(19) United States
(12) Patent Application Publication
(10) Pub. No.: US 2026/0228689 A1
(43) Pub. Date: Aug. 6, 2026

(54) SYSTEMS AND METHODS FOR MANAGING INVENTORY

(71) Applicant: Walmart Apollo, LLC, Bentonville, AR (US)

(72) Inventors: Hafeez Palagiri, Melissa, TX (US); Morgan J. Sannes, Conshohocken, PA (US); Arpan Bajoria, Cupertino, CA (US); Brandon J. Easterling, Bella Vista, AR (US); Kushagra Saini, Ajmer (IN); Pranav Aggarwal, Navi Mumbai (IN); Naman Kaushik, Hapur (IN); Rohit Sharma, Mathura (IN); Manish Kumar, Bangalore (IN); Ramanujam Ramaswamy Srinivasa, Bengaluru (IN)

(21) Appl. No.: 19/466,097

(22) Filed: Jan. 30, 2026

Related U.S. Application Data
(60) Provisional application No. 63/752,083, filed on Jan. 31, 2025.

(51) Int. Cl. G06Q 10/087; G06V 10/10; G06V 10/44; G06V 10/82; G06V 20/52

(52) U.S. Cl. CPC G06Q 10/08772; G06V 10/16; G06V 10/44; G06V 10/82; G06V 20/52

(57) ABSTRACT

Examples may relate to inventory management within a facility. In some embodiments, a facility has a first camera associated with a location and mounted to view a storage area and capture images of the storage area. A control circuit or processing resource can execute a machine learning model trained to: detect boundary features of a bin depicted in a first image; determine a bin location of the bin based on the location associated with the first camera; identify at least one inventory item stored in the bin based on a respective identifier associated with the at least one inventory item; and/or update inventory data based on identifying the at least one inventory item, wherein the inventory data is associated with the bin and at least one of the bin location and the location associated with the first camera.

### CROSS-REFERENCE TO RELATED APPLICATIONS

This application claims the benefit of U.S. Provisional Application No. 63/752,083 filed Jan. 31, 2025, which is incorporated herein by reference in its entirety.

### BACKGROUND

Many facilities store inventory items. Inventory items frequently change locations within a facility as inventory is added to the facility, removed from the facility, and/or moved to other locations in the facility. Inventory management typically involves periodic scanning of identifiers of inventory items by workers using handheld scanning equipment, the scanned identifiers input to a computer managing the inventory.

### BRIEF DESCRIPTION OF DRAWINGS

Various examples will be described below with reference to the following figures.

FIG. 1 is a block diagram of an example inventory management system in accordance with some embodiments.

FIG. 2 is a perspective view of an example facility in accordance with several embodiments.

FIG. 3A is a diagram of an example camera arrangement with non-overlapping fields of views in accordance with some embodiments.

FIG. 3B is a diagram of an example camera arrangement with overlapping fields of views in accordance with several embodiments.

FIG. 4 is an example image of an example bin in a facility in accordance with some embodiments.

FIG. 5 is an example image of an example bin in a facility having overlaid indicators in accordance with several embodiments.

FIG. 6 is a perspective view of an example inventory management system in accordance with several embodiments.

FIG. 7 shows example images obtained by cameras in accordance with several embodiments.

FIG. 8A is a block diagram of an example inventory management system in accordance with several embodiments.

FIG. 8B is a block diagram of an example inventory management system in accordance with several embodiments.

FIG. 8C is a block diagram of an example inventory management system in accordance with several embodiments.

FIG. 8D is a block diagram of an example inventory management system in accordance with several embodiments.

FIG. 9 is example inventory management system including an example processing resource and example computer readable medium in accordance with several embodiments.

FIG. 10A is a flowchart of an example process for use in inventory management in accordance with several embodiments.

FIG. 10B is a flowchart of an example process for use in inventory management in accordance with several embodiments.

FIG. 10C is a flowchart of an example process for use in inventory management in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Although certain actions and/or steps may be described or depicted in a particular order of occurrence, those actions and/or steps are not limited to that order and may be performed in a different order or occurrence. The terms and expressions used herein have the ordinary technical meaning as is accorded to such terms and expressions except where different specific meanings have otherwise been set forth herein.

### DETAILED DESCRIPTION

Generally speaking, examples are described useful to manage inventory within a facility. In some embodiments, a system for inventory management within a facility includes: a first camera mounted to view a storage area storing inventory items, the first camera is associated with a location in the facility, where the first camera is to capture images of the storage area; and a control circuit to execute a machine learning model. The machine learning model is trained to: detect boundary features of a bin depicted in a first image captured by the first camera; determine a bin location of the bin based on the location associated with the first camera; identify at least one inventory item of the inventory items stored in the bin based on a respective identifier associated with the at least one inventory item; and update inventory data stored in a database based on identifying the at least one inventory item, where the inventory data is associated with the bin and at least one of the bin location and the location associated with the first camera.

In some embodiments, a method for inventory management within a facility includes capturing, by a first camera mounted to view a storage area storing inventory items, images of the storage area, where the first camera is associated with a location in the facility; detecting, by a machine learning model, boundary features of a bin depicted in a first image captured by the first camera; determining, by the machine learning model, a bin location of the bin based on the location associated with the first camera; identifying, by the machine learning model, at least one inventory item of the inventory items stored in the bin based on a respective identifier associated with the at least one inventory item; and updating, by the machine learning model, inventory data stored in a database based on identifying the at least one inventory item, where the inventory data is associated with the bin and at least one of the bin location and the location associated with the first camera.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in but is not limited to at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

Conventional inventory management systems may have sub-optimal accuracy when managing the quantity and location of inventory within a facility. Generally, conventional inventory management methods often require significant amounts of time and user interaction to identify and manage inventory. User interaction may result in decreased accuracy of inventory location and quantity, which in turn negatively impacts in-store and online shopping experiences as items may be incorrectly placed and/or not in stock when inventory records indicate an item to be at a certain location and/or in-stock. On the contrary, the present disclosure describes inventory management systems and methods which improve accuracy of inventory records by at least more regularly (e.g., continuously) monitoring a facility with mounted cameras and substantially less user interaction and/or no user interaction to maintain real-time or near real-time accurate inventory. As a result, benefits of some embodiments may include reduction and/or elimination of user input, reduction of time for inventory management, and/or improvement of accuracy by passively monitoring and updating inventory records. In some embodiments, a user may now be directed to a location within the facility with items designated for picking. Inventory management systems and methods are described in further detail herein. In some embodiments, use of some disclosed approaches may improve computer and sensor operation by locally inferring spatial inventory changes from camera viewpoints, which may lead to reducing database update latency and reducing repeated manual identifier scanning. Further, in some embodiments, processing resource usage is more efficient and complete since inventory accounting and discrepancies can occur at discrete points when images are captured and processed as opposed to spread over time due to sporadic manual identifier scanning.

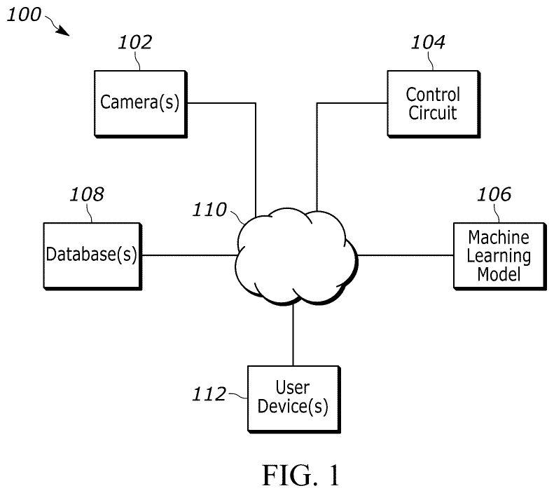

FIG. 1 shows an inventory management system 100 in accordance with some embodiments. The inventory management system 100 includes at least one camera 102, at least one control circuit 104, at least one machine learning model 106, at least one database 108, and at least one user device 112 communicatively coupled over at least one communication network 110. Generally, the inventory management system 100 identifies and monitors inventory in a facility and updates the location and quantity of items within the facility based on changes determined. In some embodiments, a facility includes a retail store, a distribution center, and a fulfillment center, to name a few.

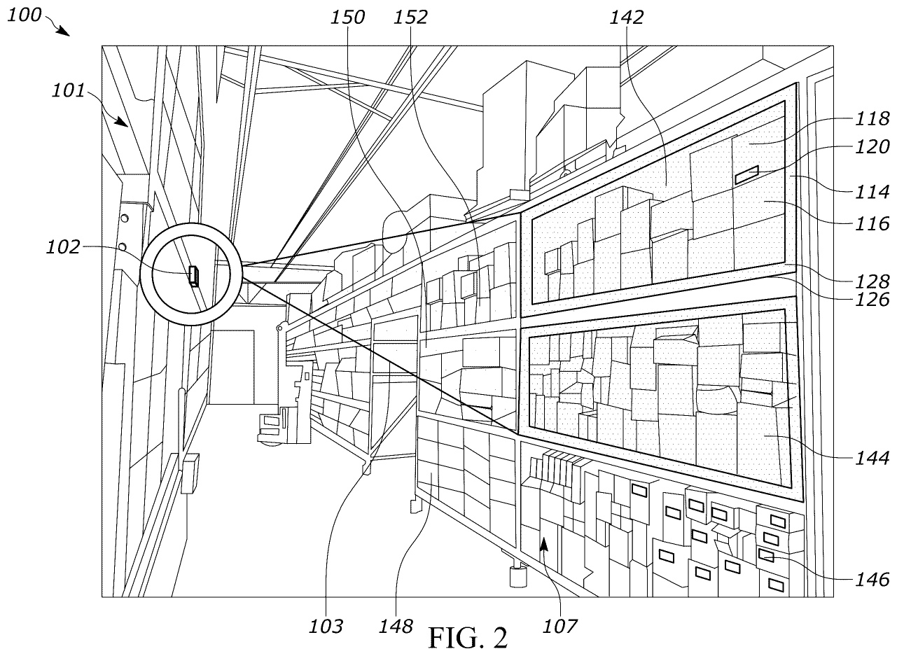

The camera(s) 102 may be any suitable camera able to capture images of a storage area storing inventory items. In the present embodiment, the cameras 102 are generally fixed/mounted with a fixed field of view (e.g., the field of view 103 shown in FIG. 2), however, it is generally contemplated that any other type of camera may be used. For example, in some embodiments, the cameras 102 may be non-fixed (e.g., movable cameras that are not user held or handheld) and/or have variable fields of view 103. In some embodiments, the cameras 102 may continuously monitor their respective fields of view 103, while in some aspects the cameras 102 may be to capture images of their respective fields of views 103 at pre-determined periods of time and/or event (e.g., every fifteen minutes, after movement is detected, after an indication is sent by a user to capture an image, and so forth). There may be any number of cameras 102 spaced in any suitable configuration.

The control circuit 104 may include any suitable processing resource to execute instructions stored in a computer-readable storage memory (e.g., random access memory, read-only memory, hard disk drive, solid-state drive, optical disc, storage network, network-attached storage, storage area network, and/or any non-transitory, computer-readable storage medium). In this context, the terms control circuit 104 and controller may refer broadly to any microcontroller, computer, or processor-based device with processor, memory, and programmable input/output peripherals, which is generally designed to govern the operation of other components and devices. It is further understood that the control circuit 104 and/or controller may be operatively coupled to common accompanying accessory devices, including memory, transceivers for communication with other components and devices, etc. The common accompanying accessory devices, including memory, transceivers for communication with other components and devices are architectural options that are well known and understood in the art and require no further description here. The control circuit 104 or controller may carry out one or more of the steps, actions, and/or functions described herein.

The machine learning model 106 may be trained using any suitable machine learning algorithm(s) including decision trees, random forest, neural networks, deep learning, and so forth. In the present embodiment, the machine learning model 106 is operatively coupled with the control circuit 104 via the communication network 110, and the control circuit 104 may execute the machine learning model 106. In some embodiments, instructions stored in memory (e.g., of the control circuit 104 and/or external memory) may cause the control circuit 104 to output information and/or data from the user device(s) 112, the database(s) 108, and/or the camera(s) 102 to be used by the machine learning model 106. The machine learning model 106 is generally pre-trained with data, and in some embodiments may be re-trained by any combination of manually input re-training data and/or self-learning methods.

The database(s) 108 may be any suitable databases (e.g., hierarchical databases, relational databases, non-relational databases, object oriented databases, and so forth) to store data relevant to the inventory management system 100. In some embodiments, data stored in the database(s) 108 includes inventory data (e.g., item location, item pricing, number of SKUs of an item, historical sales information of an item, etc.), camera data (e.g., images taken from cameras 102 which may be associated with specific areas within a facility/storage area), order fulfillment data (e.g., customer orders to be fulfilled by the items stored in the facility/storage area, historical customer orders, etc.), training and/or retraining data to be used by the machine learning model 106, and so forth. Any suitable data relevant to the systems and processes described herein may be stored in one or more databases 108.

The communication network(s) 110 may be any suitable network or communication method such as, for example, a local area network (LAN), the Internet, wide area network (WAN), etc., communication link, other networks or communication channels with other devices and/or other such communications (not shown) or combination of two or more of such communication methods. There may be any combination of wired connections and/or wireless connections (e.g., Wi-Fi, Bluetooth, cellular, RF, and/or other such wireless communication) between elements of the inventory management system 100.

The user device(s) 112 may be operatively coupled to the control circuit 104 and may include, but are not limited to, smartphones, tablets, laptops, computers, and/or other such computing systems that enable a user to communicate with the inventory management system 100. In some aspects, one or more user devices 112 are part of the inventory management system 100 and/or one or more user devices 112 are separate and distinct from the inventory management system 100. The inventory management system 100 can further include and/or be in communication with one or more communication networks 110. The user device(s) 112 can allow a user to interact with the inventory management system 100 and receive information through the system. In some instances, the user device 112 may include a display and/or one or more user inputs, such as buttons, touch screen, track ball, keyboard, mouse, etc., which can be part of or wired or wirelessly coupled with the inventory management system 100.

Further referring to FIG. 2, the inventory management system 100 may be implemented in a facility 101 in accordance with some embodiments. The facility 101 may be any suitable facility storing inventory items 118 to be managed (a retail store, a distribution center, and a fulfillment center, to name a few). In some aspects, the facility 101 may be a retail facility and the inventory items 118 to be managed are items for sale within the facility (e.g., sales floor, store room, back room, stock room, warehouse, to name a few), while in some embodiments, the facility 101 is any facility with items not for sale to be managed (e.g., an office building with supplies for the employees use to be managed). The facility 101 (and more specifically a storage area 107 of the facility 101) may comprise various storage structures which define aisles within the storage area 107. The storage structures generally include multiple vertically spaced levels of bins 116 spanning a storage structure. In some embodiments, the storage area 107 includes at least a portion of one of a sales floor of the facility 101 and a backroom of the facility 101. The bins 116 (which may also be referred to herein as shelves, sections, receptacles, etc.) are generally sectioned areas of a storage structure to store items (e.g., inventory items 118). In the embodiment shown in FIG. 2, the storage structure includes six bins 116 (e.g., a first bin 142, a second bin 144, a third bin 146, a fourth bin 148, a fifth bin 150, and a sixth bin 152) in the form of two columns with three levels of bins 116. It is generally understood that the described configuration of bins 116 is for example only, and that any suitable number, spacing, configuration, dimensions, and so forth may be utilized.

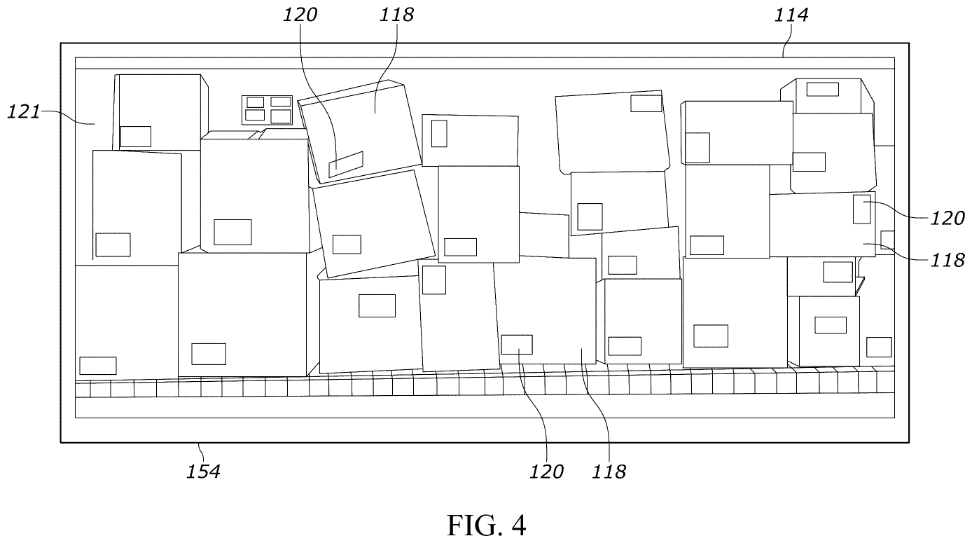

FIG. 2 shows a view of the facility 101 including a first camera 102 mounted to view a storage area 107 of the facility 101 storing inventory items 118. In some embodiments, the first camera 102 is associated with a location in the facility 101. For example, the first camera 102 may be located at a specific location within the facility 101 associated with an aisle, a position along the length of an aisle, a vertical level of the aisle, and so forth. In some embodiments, the location in the facility 101 associated with each camera 102 is stored in the database 108. Generally, the cameras 102 are to capture images (e.g., an image 121 as shown in FIG. 4) of the storage area 107. As shown in FIG. 2, a first camera 102 may have a field of view 103 viewing two bins 116 (e.g., the first bin 142 and the second bin 144), though it is generally contemplated that a camera 102 may have any suitable field of view 103 including any number of bins 116 (e.g., one bin 116, part of a bin 116, multiple bins 116, etc.). Further referring to FIG. 4, an image 121 taken of a bin 116 by a camera 102, and the image 121 depicts multiple inventory items 118 each including respective identifiers 120 is shown in accordance with some embodiments.

In some embodiments, an image 121 taken by the camera 102 is stored in the database 108, and the control circuit 104 executes the machine learning model 106 to detect boundary features 114 (shown in FIG. 2) of at least one bin 116 depicted in an image 121 captured by a respective camera 102. The boundary features 114 are generally the boundaries of a bin 116. For example, the boundary features 114 may include at least one of corners 128 of the bin 116 or edges 126 of the bin 116. In other words, the dimension of a specific bin 116 are identified by the machine learning model 106 in order to distinguish individual bins 116 from one another. In some embodiments, the control circuit 104 executing the machine learning model 106 may identify a bin 116 by augmenting the image 121 with a boundary box 154 (shown in FIG. 4). In some embodiments, the machine learning model 106 may receive the image 121 already augmented with boundary boxes 154 by another machine learning model. In some embodiments, the machine learning model 106 determines a bin location of a bin 116 based on the location associated with the camera(s) 102 that took the image 121 depicting the bin 116. In some embodiments, each bin or one or more bins in a storage structure may be assigned a particular camera 102. Thus, the control circuit 104 executing the machine learning model 106 may determine the location of the bin based on the camera 102 that took the image 121. In some embodiments, the image 121 prior to being sent and/or stored in a database may be associated with a particular identifier associated with the camera 102 that captured the image 121.

In some embodiments, the machine learning model 106 identifies/recognizes at least one inventory item 118 of the inventory items 118 stored within the bin 116 based on a respective identifier 120 associated with the at least one inventory item 118. The identifiers 120 may, for example, be any suitable identifier such as a barcode, an RFID tag, an ARUCO marker, and so forth. In one example, a camera 102 may capture an image 121 including three bins, and the machine learning model 106 may identify each bin within the image 121 as a distinct bin. Further, the inventory items 118 within each bin may be assigned to the distinct bin in which they reside by the machine learning model 106. In some aspects, the machine learning model 106 may identify inventory items 118 located outside of a bin (e.g., if the inventory items 118 do not fit in a bin (e.g., a TV), the inventory items 118 are located elsewhere in the facility (e.g., on a pallet), and so forth) based on an image taken by a camera 102 with a field of view 103 not directed towards a bin. In some embodiments, in a storage area where multiple bins (e.g., 3 bins) may normally be expected by the machine learning model 106 in a captured image but, due to circumstances, such as accommodating a larger inventory item (e.g., a big TV) to be placed in the storage area and the multiple bins reconfigured as a single bin, the machine learning model 106 is trained to treat the multiple bins as a single bin when performing the functions described herein. Generally, the location of the inventory items 118 is associated with the location of the camera 102 capturing an image 121 in which respective inventory items 118 reside.

In some embodiments, the machine learning model 106 updates the inventory data stored in the database 108 based on the identification of the at least one inventory item 118. The inventory data updated may include data associated with the bin 116 storing the inventory item(s) 118 such as the bin location of the bin 116 storing the inventory item(s) 118 and the location associated with the camera 102 that captured the image 121 depicting the bin 116. It is generally contemplated, that images 121 taken from cameras 102 with respective fields of views 103 not encompassing a bin (e.g., of a pallet or alternate area within the facility) may further cause the machine learning model 106 to update inventory data in embodiments where inventory items 118 are identified within the respective images 121.

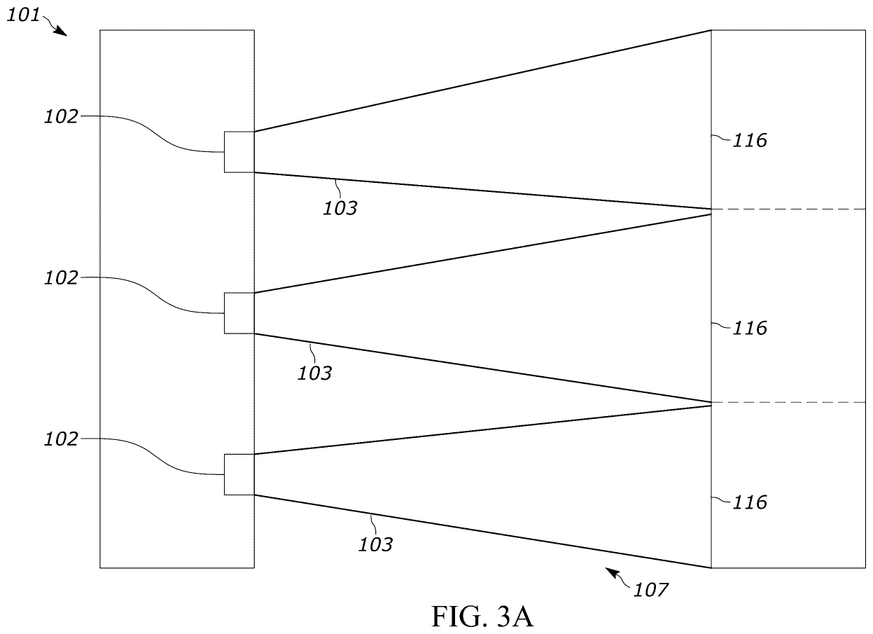

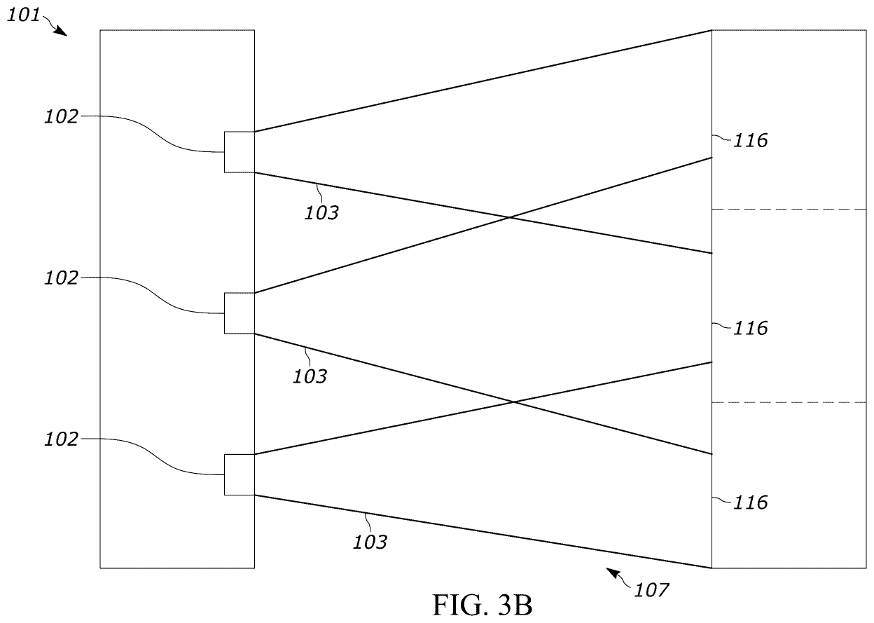

Further referring to FIGS. 3A and 3B, the inventory management system 100 may further include at least a second camera 102 associated with a respective location within the facility 101. Generally, each camera 102 is to capture images 121 of the storage area 107 with respective fields of view 103. In the shown embodiments, three cameras 102 are viewing three bins 116. FIG. 3A shows the cameras 102 with non-overlapping fields of views 103, while FIG. 3B shows the cameras 102 with overlapping fields of views 103. Generally, the machine learning model 106 is to detect boundary features 114 of each bin depicted in images 121 captured by the plurality of cameras 102 and to identify at least one inventory item 118 stored in the respective bins 116. The machine learning model 106 may further determine a bin location of each bin 116 based on the location associated with the respective camera 102 that captured the image 121 depicting a respective bin 116. In some embodiments, the machine learning model 106 may access one of the databases 108 to determine the bin location of a bin 116 based on a stored association between the location associated with the camera 102 that captured the image 121 and the bin location of the bin 116.

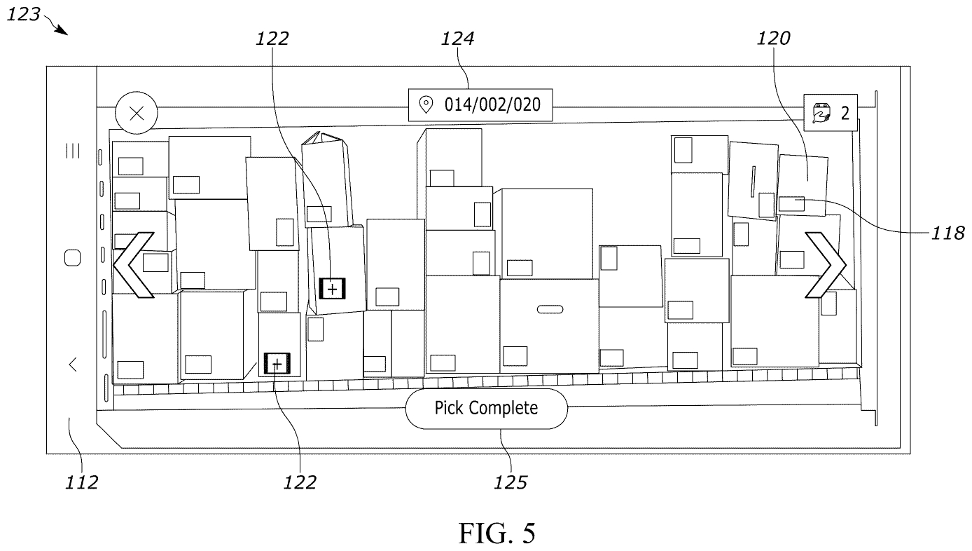

FIG. 5 shows a user device 112 depicting a version 123 of the image 121. In some embodiments, the inventory management system 100 further includes an application executed on a user device 112 (such as a device used by an associate of a retail facility during an order fulfillment process). The application, for example, may be stored and executed by a user device 112 and/or be communicatively coupled with the cameras 102, the control circuit 104, the machine learning model 106, and/or the database(s) 108 via the at least one communication network 110 such that the processes described herein are executed external to the user device 112. In some embodiments, the processes described herein may be executed with any combination of external and internal to a user device 112.

In some embodiments, such as the embodiments shown in FIG. 5, the machine learning model 106 further determines that the at least one inventory item 118 identified includes an inventory item 118 designated to be picked (e.g., as part of an order fulfillment process, a sales floor process, an inventory replenishment process, etc.) by an associate of the facility 101. The machine learning model 106 may then generate a version 123 of the image 121 captured by a respective camera 102 to depict the respective bin 116 with an indicator 122 indicating that the inventory item 118 is designated to be picked by the associate. In some embodiments, the machine learning model 106 further outputs the version 123 of the image 121 to the user device 112 for display to the associate to pick the inventory item 118. In further embodiments, the machine learning model 106 may output, for display on the user device 112, the bin location 124 of the bin 116 including the inventory item(s) 118 to be picked in order to direct a user/associate to the inventory item(s) 118. In embodiments with multiple cameras 102, each bin 116 including inventory item(s) 118 designated for picking may be associated with a respective version 123 of an image 121 depicting the respective bin 116 with indicators 122 indicating the respective inventory item(s) 118 to be picked. Any number of versions 123 of images 121 may be output to a user device 112 dependent on the number of inventory items 118 to be picked by the user. In some embodiments, multiple associates/users receive versions 123 of images 121 depicting inventory items 118 to be picked by the respective user such that each subset of inventory items 118 output to a respective user device 112 is different from a subset of inventory items 118 output to a different user device 112. For example, in some embodiments, the subset of inventory items 118 indicated for picking on a first user device 112 may be associated with a first order to be fulfilled while the subset of inventory items 118 indicated for picking on a second user device 112 may be associated with a second order to be fulfilled.

As shown in FIG. 5, the version 123 of the image 121 may be the image 121 with indicators 122 overlayed on top of the image 121. In the shown embodiment, the identifiers 120 of the inventory items 118 in the image 121 are indicated, and the identifiers 120 of the inventory items 118 to be picked are overlayed with the indicators 122. While the indicators 122 are shown to be boxes with a plus sign, it is generally contemplated that the indicators 122 may have any suitable size, shape, color, location, etc., to indicate a specific inventory item 118 to be picked. In some embodiments, the application may allow a user to navigate (e.g., by swiping or tapping) through multiple images 121. In some embodiments, a user can tap the arrows on either end of the screen of the user device 112 to navigate from an image 121 to another image 121. In some embodiments, the application depicts the number of inventory items 118 to be picked (e.g., the indicator in the top right corner of the user device 112). The number of inventory items 118 indicated may, for example, be the number of inventory items 118 to be picked shown in the version 123 of a single image 121 or may be the number of items 118 to be picked across all images 121 output to the user device 112 for display. The application may further include a back button (e.g., the circled x in the top left corner of the user device 112) in order to allow a user to navigate from the version 123 of the image 121 to alternate and/or additional interfaces/screens of the application. Further, the application may include a picking indication 125 (e.g., the pick complete button) to allow a user to indicate when the inventory items 118 designated for picking have been picked. While the embodiment shown in FIG. 5 depicts a user device 112 (in the form of a mobile device including a touchscreen) depicting a version 123 of an image 121 overlayed with indicators 122, navigation arrows, a back button, an indicator with the number of inventory items 118 to be picked, a picking indication 125 in the form of a pick complete button, and/or a bin location 124, it is generally contemplated that any other configuration of buttons, indicators, and the like may be utilized.

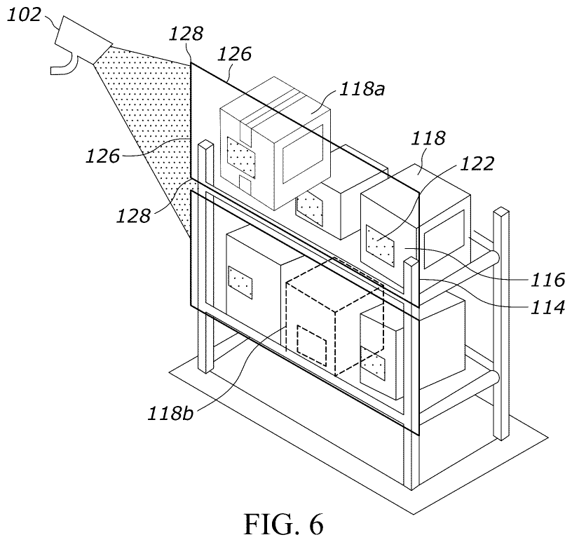

Further referring to FIG. 6, another view of the inventory management system 100 is shown in accordance with some embodiments. In some embodiments, the control circuit 104 causes a respective camera 102 to capture a second image 121 of the storage area 107 upon receiving a picking indication 125 that an associate has picked a designated inventory item 118. For example, a user may indicate, via the user device 112, that a specific inventory item 118 has been picked and/or that all inventory items 118 designated for picking in a specific bin 116 have been picked. Upon receiving the picking indication 125, the control circuit 104 may cause the camera 102 associated with the bin(s) 116 which the picking indication 125 has been received for to determine that the inventory item 118 indicated for picking is no longer in the respective bin 116 based on the second image 121 captured. The control circuit 104 further updates the inventory data in the database(s) 108 based on the identification that the inventory item 118 is no longer in the respective bin 116. In some embodiments, the machine learning model 106 determines that the inventory item(s) 118 are no longer in a respective bin 116 and updates the inventory data accordingly.

Still referring to FIG. 6, in some embodiments, the camera(s) 102 may capture a subsequent image 121 of the storage area 107 periodically at a pre-determined period of time after the first image 121 has been captured. For example, a camera 102 may capture images every 30 minutes regardless of receival of a picking indication 125. In some embodiments a camera 102 may capture an image 121 periodically and upon receival of a picking indication 125. Further, the machine learning model 106, in some embodiments, is trained to compare the first image 121 and the subsequent image 121 to determine a change (e.g., to the inventory items 118 residing in the bin) to the respective bin 116, and to update the inventory data based on the determined change. In some aspects, the change to the bin 116 includes a new inventory item 118a that is stored in the bin 116, a removed inventory item 118b that has been removed from and is no longer stored in the bin 116, or any combination thereof. In further embodiments, the inventory management system 100 may further include one or more sensors to detect movement relative to a bin 116, and upon detection of movement, a respective camera 102 captures a subsequent image 121 of the storage area 107.

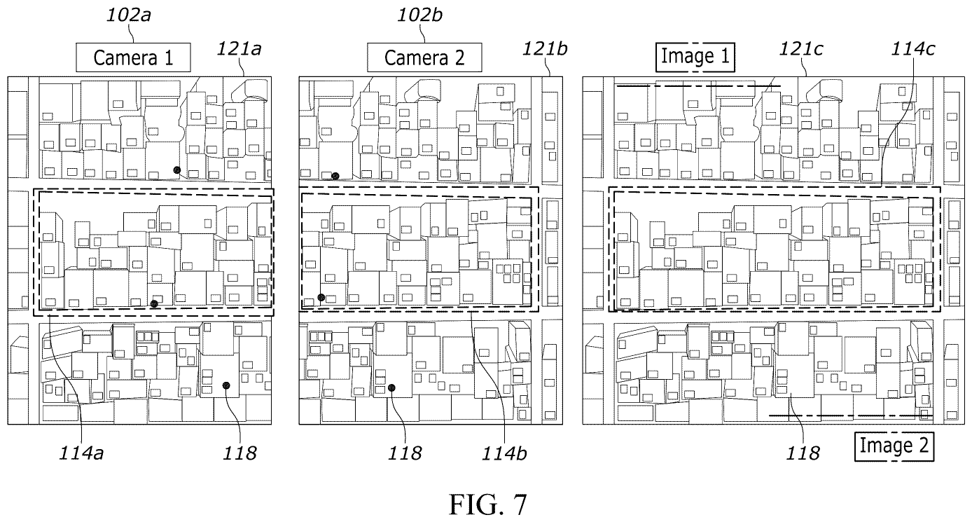

FIG. 7 shows images 121 and/or fields of views 103 as seen by multiple cameras 102 in accordance with some embodiments. In some embodiments, the inventory management system 100 further includes a first camera 102a and a second camera 102b each to capture respective images of the storage area 107. As shown, the first camera 102a captures a first image 121a of the storage area 107 and the second camera 102b captures a second image 121b of the storage area 107. As shown, in some embodiments, each of the first image 121a and the second image 121b depict separate portions of a respective bin 116, and the machine learning model 106 is trained to combine the first image 121a and the second image 121b into a combined image 121c depicting an entire image of the bin 116. In some embodiments, the machine learning model 106 is trained to combine the first and second images after a determination that these images were captured by a particular camera 102 and/or set of cameras 102. The machine learning model 106 is further to detect boundary features 114c of the entire image of the bin 116 after the first image 121a and the second image 121b have been combined. In some embodiments, the machine learning model 106 is trained to detect boundary features 114a of a first portion of the bin 116 depicted in the first image 121a and to detect boundary features 114b of a second portion of the bin 116 depicted in the second image 121b. In some embodiments, the machine learning model 106 combines the first image 121a and the second image 121b (after the boundary features 114a, 114b have been identified) into the combined image 121c depicting the entire image of the bin 116.

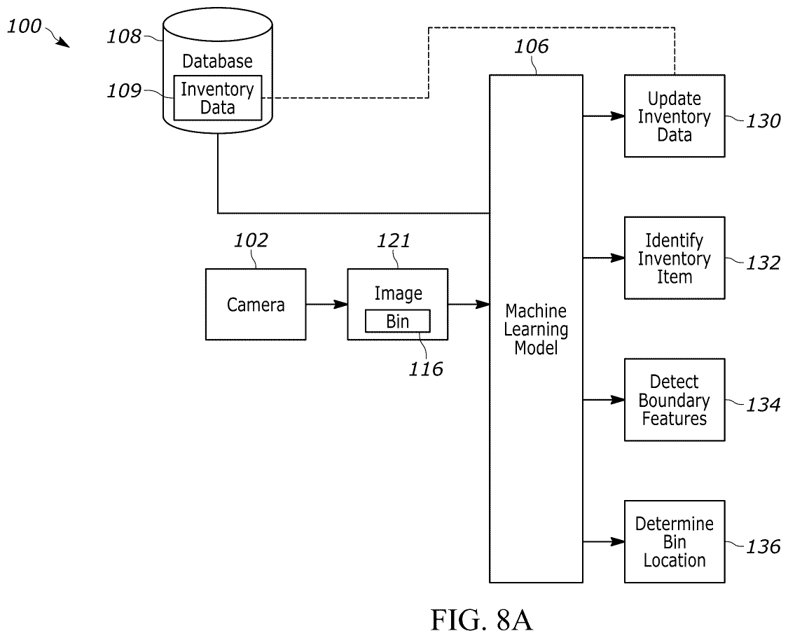

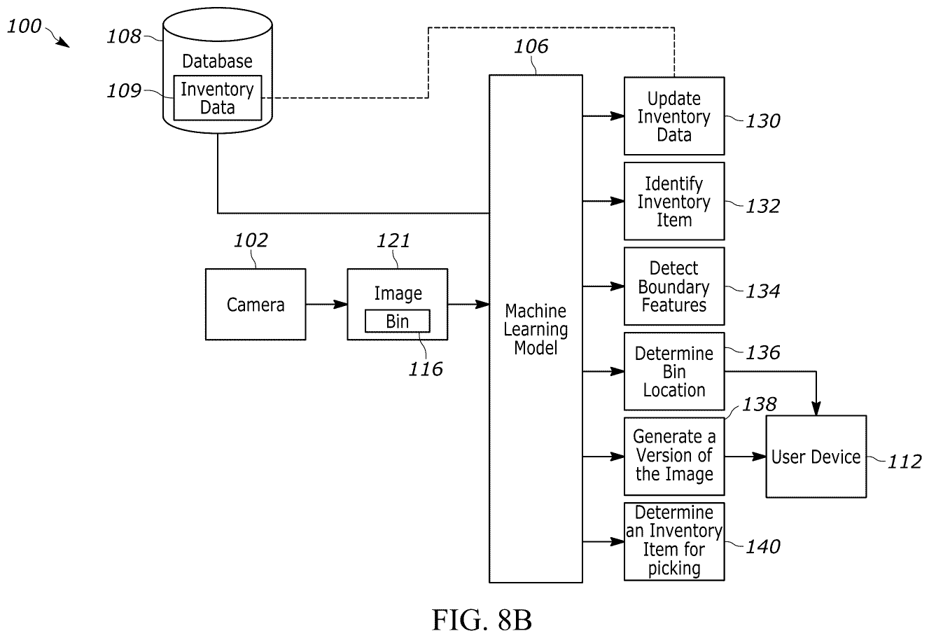

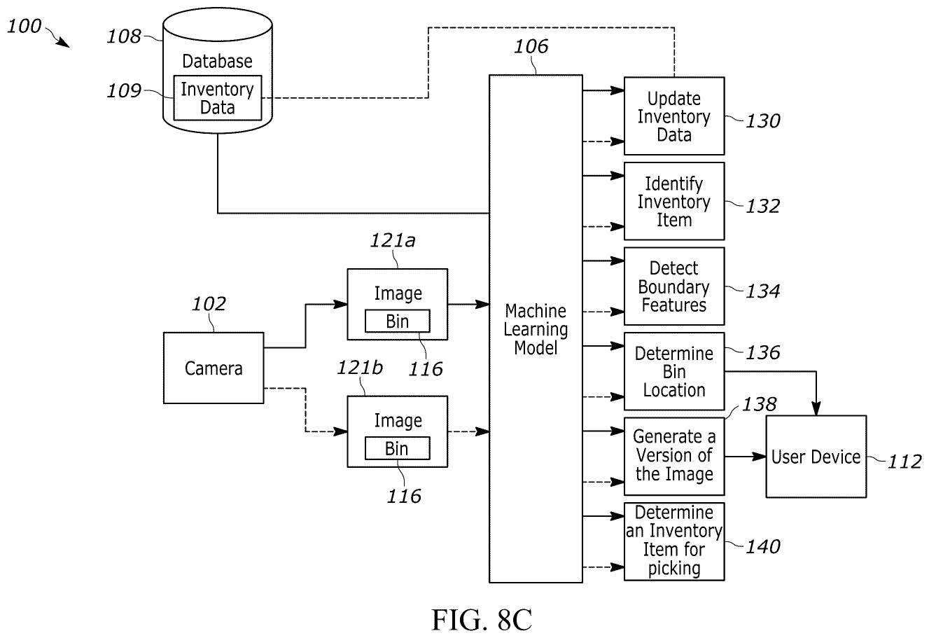

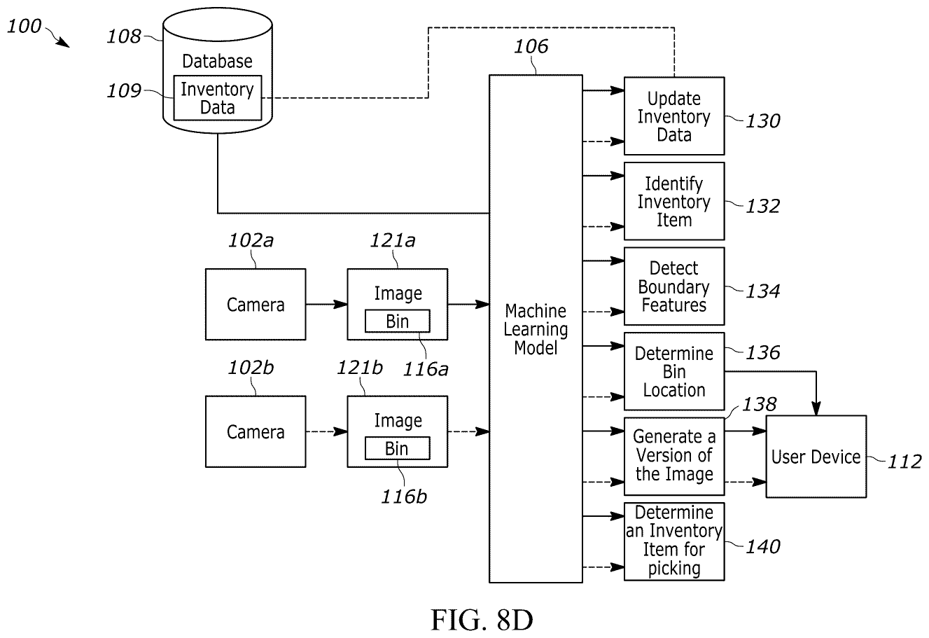

Now referring to FIGS. 8A-8D, architecture diagrams of the inventory management system 100 are shown in accordance with some embodiments. FIG. 8A shows the inventory management system 100 including a camera 102 which captures and sends an image 121 depicting a bin 116 to the machine learning model 106. The machine learning model 106 is coupled to a database 108 storing inventory data 109. The inventory data 109 is generally the inventory data described herein. The machine learning model 106 receives the image 121 and the inventory data 109 and detects boundary features at step 134, determines a bin location at step 136, identifies an inventory item at step 132, and updates the inventory data 109 at step 130. FIG. 8B is the architecture diagram of FIG. 8A optionally including a step 138 of generating a version 123 of the image 121 to be output to a user device 112 and a step 140 of determining an inventory item 118 for picking. In some embodiments, the bin location is further output to the user device 112. FIG. 8C is the architecture diagram of FIG. 8B optionally including a first image 121a and a second image 121b taken by the same camera 102 with the steps 130, 132, 136, 138, and 140. FIG. 8D is the architecture diagram of FIG. 8C with the first image 121a and the second image 121b are taken by a first camera 102a and a second camera 102b, respectively.

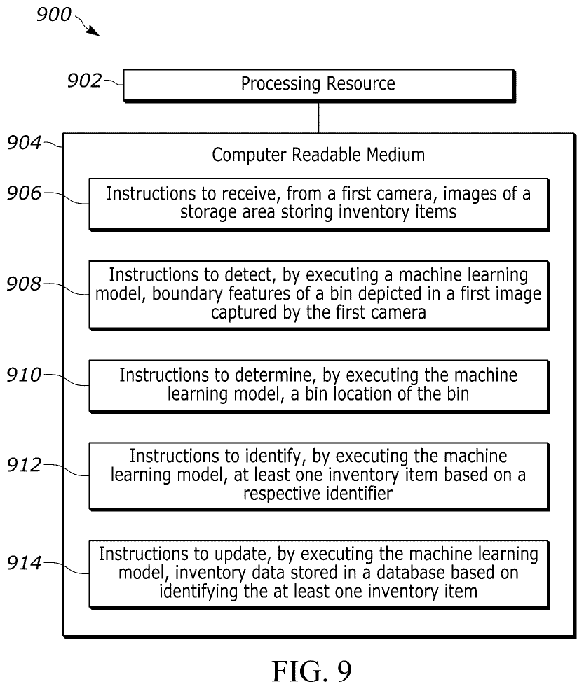

FIG. 9 shows an inventory management system 900 including a control circuit or a processing resource 902 coupled with a non-transitory machine readable medium 904 (which may be a computer readable medium) in according in accordance with some embodiments. It is generally contemplated that the inventory management system 900 may be the same as or include components of the inventory management system 100. The non-transitory machine readable medium 904 generally stores instructions for inventory management within a facility that when executed cause a processing resource 902 to perform the following steps. The processing resource 902 to receive, from a first camera mounted to view a storage area storing inventory items, images of the storage area in a first step 906. The first camera is associated with a location in the facility. At a step 908, the processing resource 902 detects, by executing a machine learning model, boundary features of a bin depicted in a first image captured by the first camera. At a step 910, the processing resource 902 determines, by executing the machine learning model, a bin location based on the location associated with the first camera. At a step 912, the processing resource 902 identifies, by executing the machine learning model, at least one inventory item of the inventory items stored in the bin based on a respective identifier associated with the at least one inventory item. At a step 914, the processing resource 902 updates, by executing the machine learning model, inventory data stored in a database based on identifying the at least one inventory item. The inventory data is associated with the bin and at least one of bin location and the location associated with the first camera. Some implementations may include more or fewer instructions than are shown in FIG. 9.

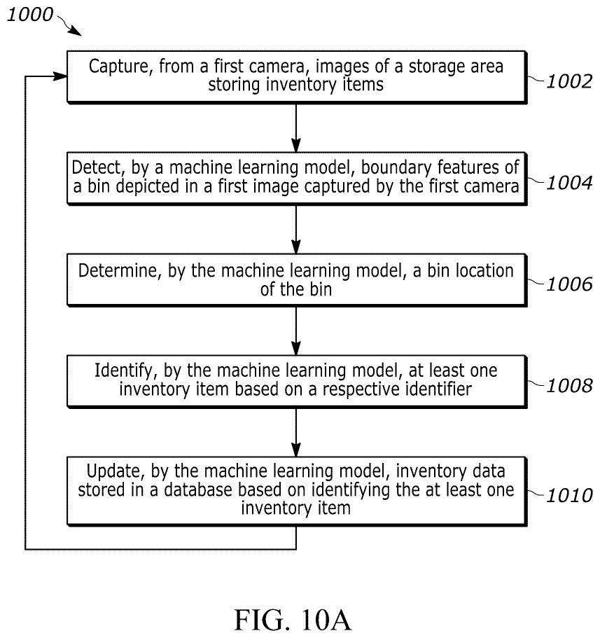

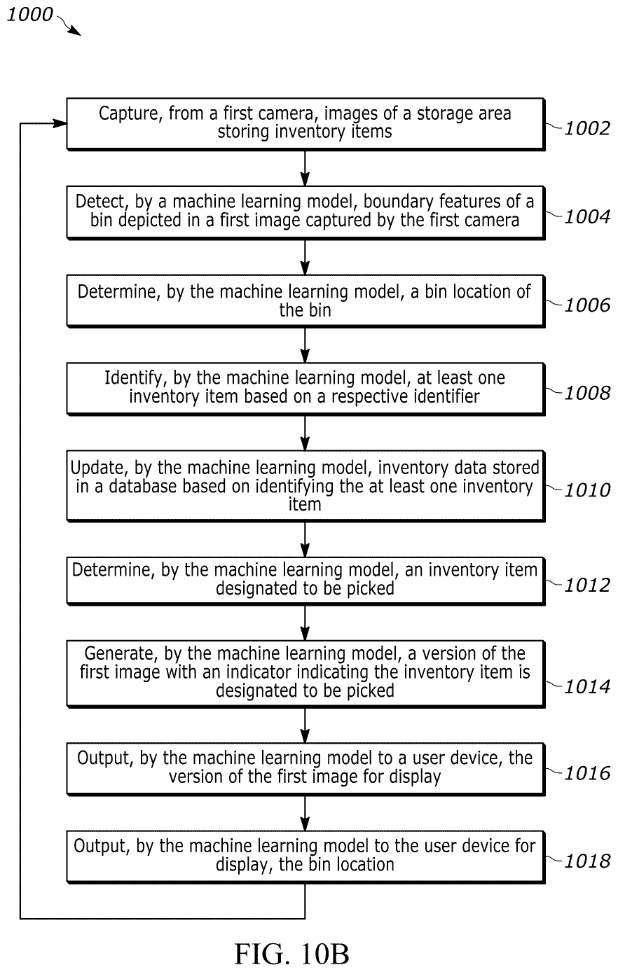

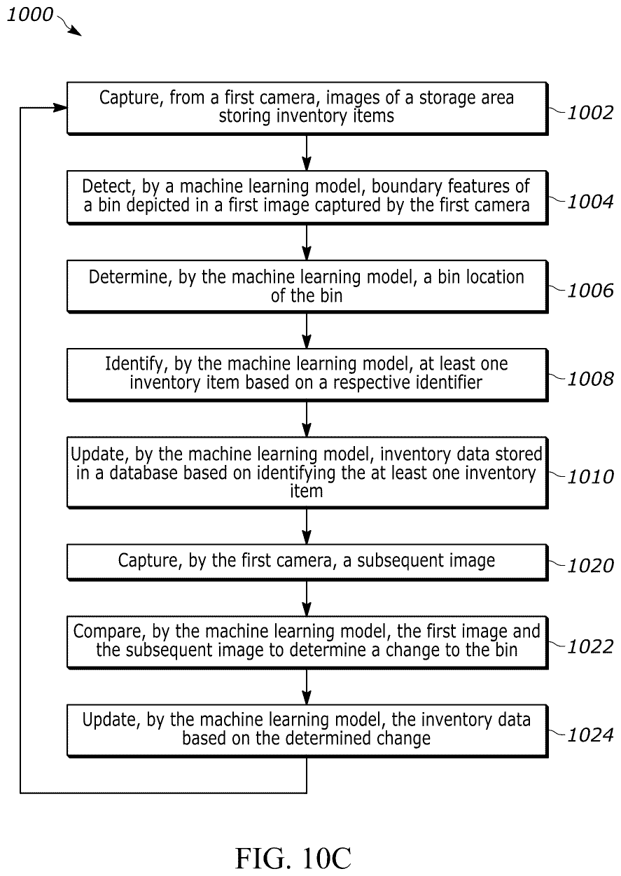

FIGS. 10A-10C show a process 1000 of inventory management in accordance with some embodiments. The process 1000 may be executed by the inventory management systems 100, 900 and/or by components of the inventory management systems 100, 900. Some embodiments may include more or fewer steps than are shown in FIGS. 10A-10C, and one or more of the steps and/or series of steps may be repeated one or more times. Although certain steps (and/or actions) may be described or depicted in a particular order of occurrence, those steps are not limited to that order, and one or more steps may be omitted, performed in a different order or occurrence, and/or executed in parallel in various embodiments.

At step 1002 the process 1000 includes capturing, by a first camera mounted to view a storage area storing inventory items, images of the storage area. In some embodiments, the first camera is associated with a location in the facility. At step 1004, the process 1000 includes detecting, by a machine learning model, boundary features of a bin depicted in a first image captured by the first camera. In some embodiments, the boundary features include at least one of corners of the bin and edges of the bin. At step 1006, the process 1000 includes determining, by the machine learning model, a bin location of the bin based on the location associated with the first camera. At step 1008, the process 1000 includes identifying, by the machine learning model, at least one inventory item of the inventory items stored in the bin based on a respective identifier associated with the at least one inventory item. At step 1010, the process 1000 includes updating, by the machine learning model, inventory data stored in a database based on identifying the at least one inventory item. In some embodiments, the inventory data is associated with the bin and at least one of the bin location and the location associated with the first camera.

As shown in FIG. 10B, proceeding step 1010, the process 1000 may further include a step 1012 of determining, by the machine learning model, that the at least one inventor item includes an inventory item designated for picking by an associate of the facility. The process 1000 may include, at step 1014, generating, by the machine learning model, a version of the first image captured by the first camera to depict the bin with an indicator indicating that the inventory item is designated to be picked by the associate. The process 1000 may include, at step 1016, outputting, by the machine learning model to a user device, the version of the first image for display to the associate to pick the inventory item. In further embodiments, the process 1000 may include a step 1018 which includes outputting, by the machine learning model to the user device for display on the user device, the bin location of the bin to direct a user to the at least one inventory item.

In further embodiments, the process 1000 may include capturing, by a second camera associated with a second location in the facility, images of the storage area. The process 1000 may include detecting, by the machine learning model, boundary features of a second bin depicted in a second image captured by the second camera. The process 1000 may include identifying, by the machine learning model, at least one inventory item stored in the second bin. The process 1000 may include determining, by the machine learning model, a second bin location of the second bin based on the second location associated with the second camera. The process 1000 may include generating, by the machine learning model, a version of the second image captured by the second camera to depict the second bin with a second indicator indicating that a second inventory item of the at least one inventory item stored in the second bin is designated to be picked by the associate. The process 1000 may further include outputting, by the machine learning model to the user device, the version of the second image and the second bin location for display to the associate to pick the second inventory item. In other words, steps 1002-1018 of FIG. 10B may be repeated for any number of additional cameras and/or bins within the facility.

As shown in FIG. 10C, proceeding step 1010, the process 1000 includes a step 1020 of capturing, by the first camera, a subsequent image of the storage area periodically at a pre-determined period of time after the first image has been captured. The process 1000 may include a step 1022 of comparing, by the machine learning model, the first image and the subsequent image and determining a change to the bin. Generally, the change to the bin includes at least one of a new inventory item being stored in the bin or an inventory item being removed from the bin or any combination thereof. The process 1000 may include a step 1024 of updating, by the machine learning model, the inventory data based on the determined change. In alternate embodiments (not shown), the process 1000 includes causing the first camera to capture a second image of the storage area upon receiving and indication that the associate has picked the inventory items. The process 1000 may further include determining, by the machine learning model, that the inventory item is not in the bin based on the second image. The process 1000 may further include updating, by the machine learning model, the inventory data based on the identification that the inventory item is not in the bin. In other words, the cameras may take subsequent images at various intervals (e.g., periodic, continuous, after a user indication, and so forth) in order to determine changes to the inventory items within a bin.

In some embodiments (not shown), the process 1000 may include capturing, by a second camera associated with the location in the facility, images of the storage area. The process 1000 may include combining, by the machine learning model, the first image and a second image into a combined image, wherein the combined image depicts an entire image of the bin and the first image and the second image each depict a separate portion of the bin. The process 1000 may include detecting, by the machine learning model, boundary features of the entire image of the bin. In other words, multiple cameras associated with the same area in a facility capture images of portions of a bin such that when combined the images depict an entire bin. In the present embodiment, the boundary features of the bin are detected after the individual images have been combined. In alternate embodiments (not shown), the process 1000 may further include capturing, by a second camera associated with the location in the facility, images of the storage area. The process 1000 may further include detecting, by the machine learning model, boundary features of a first portion of the bin depicted in the first image and detecting, by the machine learning model, boundary features of a second portion of the bin depicted in a second image captured by the second camera. The process 1000 may further include combining, by the machine learning model, the first image and the second image into a combine image such that the combined image depicts an entire image of the bin. In other words, boundary features of images capturing portions of bins may be determined before the images are combined.

Those skilled in the art will recognize that a wide variety of other modifications, alterations, and combinations can also be made with respect to the above described embodiments without departing from the scope of the disclosure.

1. A system for inventory management within a facility comprising:
a first camera mounted to view a storage area storing inventory items, the first camera is associated with a location in the facility, wherein the first camera is to capture images of the storage area; and
a control circuit to execute a machine learning model trained to:
detect boundary features of a bin depicted in a first image captured by the first camera;
determine a bin location of the bin based on the location associated with the first camera;
identify at least one inventory item of the inventory items stored in the bin based on a respective identifier associated with the at least one inventory item; and
update inventory data stored in a database based on identifying the at least one inventory item, wherein the inventory data is associated with the bin and at least one of the bin location and the location associated with the first camera.

2. The system of claim 1, wherein the machine learning model is further trained to:
determine that the at least one inventory item comprises an inventory item designated to be picked by an associate of the facility;
generate a version of the first image captured by the first camera to depict the bin with an indicator indicating that the inventory item is designated to be picked by the associate; and
output to a user device, the version of the first image for display to the associate to pick the inventory item.

3. The system of claim 2, wherein the machine learning model is further trained to output, for display on the user device, the bin location of the bin to direct a user to the at least one inventory item.

4. The system of claim 2, further comprising a second camera associated with a second location in the facility, the second camera being to capture images of the storage area;
wherein the machine learning model is further trained to:
detect boundary features of a second bin depicted in a second image captured by the second camera;
identify at least one inventory item stored in the second bin;
determine a second bin location of the second bin based on the second location associated with the second camera;
generate a version of the second image captured by the second camera to depict the second bin with a second indicator indicating that a second inventory item of the at least one inventory item stored in the second bin is designated to be picked by the associate; and
output, to the user device, the version of the second image and the second bin location for display to the associate to pick the second inventory item.

5. The system of claim 2, wherein the control circuit is further to:
cause the first camera to capture a second image of the storage area upon receiving an indication that the associate has picked the inventory item;
determine that the inventory item is not in the bin based on the second image; and
update the inventory data based on identification that the inventory item is not in the bin.

6. The system of claim 1, wherein the first camera is further to capture a subsequent image of the storage area periodically at a pre-determined period of time after the first image has been captured, and the machine learning model is further trained to:
compare the first image and the subsequent image and determine a change to the bin; and
update the inventory data based on determining the change,
wherein the change to the bin comprises at least one of a new inventory item is stored in the bin or an inventory item has been removed from the bin.

7. The system of claim 1, wherein the boundary features comprise at least one of corners of the bin and edges of the bin.

8. The system of claim 1, further comprising a second camera associated with the location in the facility, wherein the second camera is to capture images of the storage area;
wherein the machine learning model is further trained to:
combine the first image and a second image into a combined image, wherein the combined image depicts an entire image of the bin, and wherein the first image and the second image each depict a separate portion of the bin; and
detect boundary features of the entire image of the bin.

9. The system of claim 1, further comprising a second camera associated with the location in the facility, wherein the second camera is to capture images of the storage area;
wherein the machine learning model is further trained to:
detect boundary features of a first portion of the bin depicted in the first image;
detect boundary features of a second portion of the bin depicted in a second image captured by the second camera; and
combine the first image and the second image into a combined image, wherein the combined image depicts an entire image of the bin.

10. The system of claim 1, wherein the storage area comprises at least a portion of one of a sales floor of the facility and a backroom of the facility.

11. A method for inventory management within a facility, the method comprising:
capturing, by a first camera mounted to view a storage area storing inventory items, images of the storage area, wherein the first camera is associated with a location in the facility;
detecting, by a machine learning model, boundary features of a bin depicted in a first image captured by the first camera;
determining, by the machine learning model, a bin location of the bin based on the location associated with the first camera;
identifying, by the machine learning model, at least one inventory item of the inventory items stored in the bin based on a respective identifier associated with the at least one inventory item; and
updating, by the machine learning model, inventory data stored in a database based on identifying the at least one inventory item, wherein the inventory data is associated with the bin and at least one of the bin location and the location associated with the first camera.

12. The method of claim 11, further comprising:
determining, by the machine learning model, that the at least one inventory item comprises an inventory item designated to be picked by an associate of the facility;
generating, by the machine learning model, a version of the first image captured by the first camera to depict the bin with an indicator indicating that the inventory item is designated to be picked by the associate; and
outputting, by the machine learning model to a user device, the version of the first image for display to the associate to pick the inventory item.

13. The method of claim 12, further comprising:
outputting, by the machine learning model to the user device for display on the user device, the bin location of the bin to direct a user to the at least one inventory item.

14. The method of claim 12, further comprising:
capturing, by a second camera associated with a second location in the facility, images of the storage area;
detecting, by the machine learning model, boundary features of a second bin depicted in a second image captured by the second camera;
identifying, by the machine learning model, at least one inventory item stored in the second bin;
determining, by the machine learning model, a second bin location of the second bin based on the second location associated with the second camera;
generating, by the machine learning model, a version of the second image captured by the second camera to depict the second bin with a second indicator indicating that a second inventory item of the at least one inventory item stored in the second bin is designated to be picked by the associate; and
outputting, by the machine learning model to the user device, the version of the second image and the second bin location for display to the associate to pick the second inventory item.

15. The method of claim 12, further comprising:
causing the first camera to capture a second image of the storage area upon receiving an indication that the associate has picked the inventory item;
determining, by the machine learning model, that the inventory item is not in the bin based on the second image; and
updating, by the machine learning model, the inventory data based on identification that the inventory item is not in the bin.

16. The method of claim 11, further comprising:
capturing, by the first camera, a subsequent image of the storage area periodically at a pre-determined period of time after the first image has been captured;
comparing, by the machine learning model, the first image and the subsequent image and determine a change to the bin; and
updating, by the machine learning model, the inventory data based on determining the change;
wherein the change to the bin comprises at least one of a new inventory item is stored in the bin or an inventory item has been removed from the bin.

17. The method of claim 11, wherein the boundary features comprise at least one of corners of the bin and edges of the bin.

18. The method of claim 11, further comprising:
capturing, by a second camera associated with the location in the facility, images of the storage area;
combining, by the machine learning model, the first image and a second image into a combined image, wherein the combined image depicts an entire image of the bin, and wherein the first image and the second image each depict a separate portion of the bin; and
detecting, by the machine learning model, boundary features of the entire image of the bin.

19. The method of claim 11, further comprising:
capturing, by a second camera associated with the location in the facility, images of the storage area;
detecting, by the machine learning model, boundary features of a first portion of the bin depicted in the first image;
detecting, by the machine learning model, boundary features of a second portion of the bin depicted in a second image captured by the second camera; and
combining, by the machine learning model, the first image and the second image into a combined image, wherein the combined image depicts an entire image of the bin.

20. A non-transitory machine readable medium storing instructions for a system for inventory management within a facility that, when executed, cause a processing resource to:
receive, from a first camera mounted to view a storage area storing inventory items, images of the storage area, wherein the first camera is associated with a location in the facility;
detect, by executing a machine learning model, boundary features of a bin depicted in a first image captured by the first camera;
determine, by executing the machine learning model, a bin location of the bin based on the location associated with the first camera;
identify, by executing the machine learning model, at least one inventory item of the inventory items stored in the bin based on a respective identifier associated with the at least one inventory item; and
update, by executing the machine learning model, inventory data stored in a database based on identifying the at least one inventory item, wherein the inventory data is associated with the bin and at least one of the bin location and the location associated with the first camera.
